(19) United States
(12) Patent Application Publication
(10) Pub. No.: US 2016/0318752 A1
(43) Pub. Date: Nov. 3, 2016

(54) RETRACTOR CORD BREAKAWAY DEVICE

(71) Applicant: Thompson William Wyper, Buena Park, CA (US)

(72) Inventor: Thompson William Wyper, Buena Park, CA (US)

(73) Assignee: Fueling and Service Technologies, Inc., Buena Park, CA (US)

(21) Appl. No.: 15/141,496

(22) Filed: Apr. 28, 2016

Related U.S. Application Data
(60) Provisional application No. 62/179,168, filed on Apr. 28, 2015.

(51) Int. Cl. B67D 7/32; B67D 7/04; F16L 3/14; F16L 3/16; F16B 1/00; F16L 3/01

(52) U.S. Cl. CPC B67D 7/3281; F16B 1/00; F16L 3/012; F16L 3/14; F16L 3/16; B67D 7/04; F16B 2001/0035

(57) ABSTRACT

A retractor cord breakaway device is disclosed. The device comprises a first mating portion that holds a hose and a second mating portion that is secured to the end of a retractor cord. The first mating portion is attached to the second mating portion and they are configured to break away from each other when a force greater than a designated force is applied to the hose or between the first mating portion and the second mating portion.

### CROSS-REFERENCE TO RELATED PATENT APPLICATIONS

Embodiments of the present invention relate to U.S. Provisional Application Ser. No. 62/179,168, filed Apr. 28, 2015, entitled “RETRACTOR CORD BREAKAWAY DEVICE”, the contents of which are incorporated by reference herein in its entirety and which is a basis for a claim of priority.

FIELD OF THE DISCLOSURE

The present disclosure generally relates to protection devices for fuel dispensers with retractor. More specifically, the present disclosure relates to retractor cord breakaway device that separates the retractor from hose of the fuel dispenser in the event excessive force is applied to the hose.

### BACKGROUND OF THE INVENTION

As shown by FIG. 1, transferring, conveying or sales of fuel, either liquid or gaseous, or other hazardous materials from a fixed point such as a fuel dispenser 2 to a vehicle typically involves using a flexible hose 4. Various safety codes and regulations require that an in-line hose breakaway device 6 be utilized on the delivery hose 4 such that in the event the vehicle moves from the dispensing location without first removing the hose 4 (or the nozzle 8), the breakaway device 6 will break away or disconnect in such a manner as not to damage the hose 4 and to protect both the vehicle and the fuel dispenser 2. Typical in-line hose breakaway devices 6 are configured such that when the axial force on the hose 4 (as the result of a drive off event) exceeds the preset retention force, the hose breakaway device 6 disconnects and poppet type valves seal the contents of the hose 4. Hose breakaway devices 6 use a number of different technologies such as magnetic, shear pin or spring retainer. Some can be reset by simple insertion; others require replacement parts. Typical applications for hose breakaway device include, but are not limited to, petroleum fuels (Gasoline and Diesel), gaseous fuels (Compressed Natural Gas, Propane, Hydrogen) and cryogenic fuels (Liquefied Natural Gas).

As shown by FIG. 2, some of the applications utilizing hose breakaway units 6 also utilize hose retractors 10 for convenience and to keep the hose 4 from dragging on the ground surface. Note the location for a hose breakaway device 6 on a typical petroleum dispenser system is at the hose connection on the dispenser 2. If a hose retractor cord 12 is utilized, the hose retractor is often connected on the vehicle side of the hose breakaway device 6 in such a manner that the hose retractor cord 12 is pulled away with the vehicle which can damage the dispenser 2. Common retractor cord 12 has an ultimate breaking strength of more than 800 pounds which can damage the dispenser 2 or hose retractor 10 mechanism.

Accordingly, there exists a need for retractor cord breakaway devices that protect dispenser and/or hose retractor mechanism from damage when excessive force is applied to the hose, such as a result of drive off event.

### SUMMARY OF THE INVENTION

One objective of the present disclosure is to provide retractor cord breakaway devices for fuel dispensers which allows the retractor cord to break away from the hose of the dispenser when a force exceeding a designated value is applied to the hose.

In accordance with one aspect of at least one embodiment of the present disclosure, a retractor cord breakaway device is disclosed. The device comprises: 1) a first mating portion that holds a hose and 2) a second mating portion that is secured to the end of a retractor cord; wherein the first mating portion is attached to the second mating portion and they are configured to break away from each other when a force greater than a designated force is applied to the hose.

In one embodiment, the first mating portion comprises at least two spring plungers and the second mating portion comprises at least one spherical detent and the first mating portion is attached to the second mating portion when the at least one spherical detent is inserted between the at least two spring plungers.

In yet another embodiment, the second mating portion is a spring clip clipping on the first mating portion.

In yet another embodiment, the first mating portion or the second mating portion is made of a deformable element which yields or bends when a force greater than the designated force is applied to the hose or between the first mating portion and the second mating portion, causing the first mating portion and the second mating portion to break away from each other.

In yet another embodiment, the first mating portion comprises at least one single use element that protrude into an opening on the second mating portion, and the at least one single use element shears, factures or fails when a force greater than the designated force is applied to the hose or between the first mating portion and the second mating portion, causing the first mating portion and the second mating portion to break away from each other.

In yet another embodiment, the first mating portion is attached to the second mating portion magnetically and the designated force for the first mating portion and the second mating portion to break away from each other is calculated based on magnetic attractive force.

These and other features, aspects and advantages of the present invention will become better understood with reference to the following drawings, description and claims.

### BRIEF DESCRIPTION OF THE DRAWINGS

FIG. 1 is a schematic diagram showing an exemplary prior art.

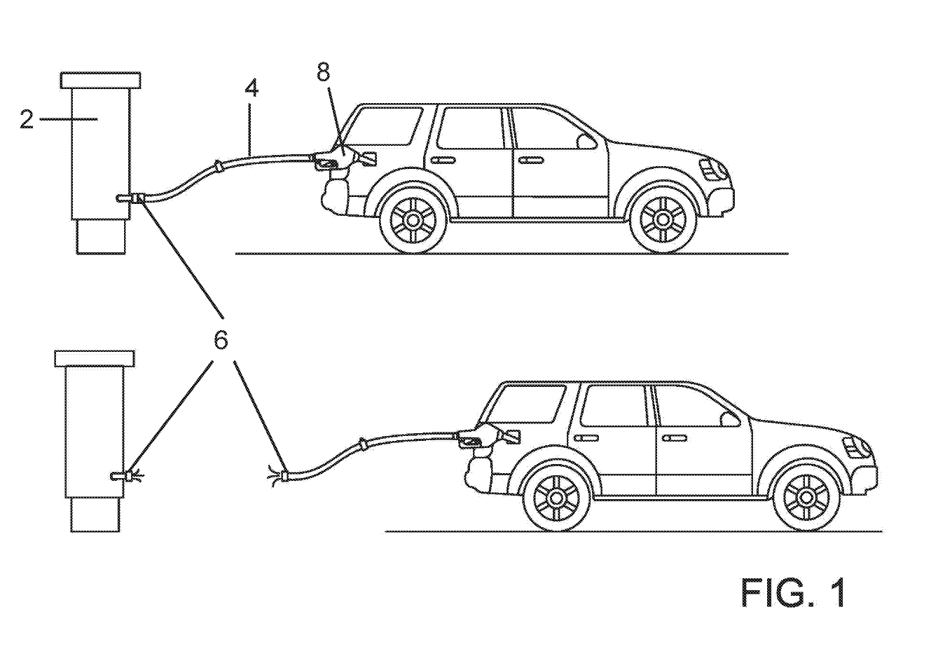

FIG. 2 is a schematic diagram showing an exemplary prior art.

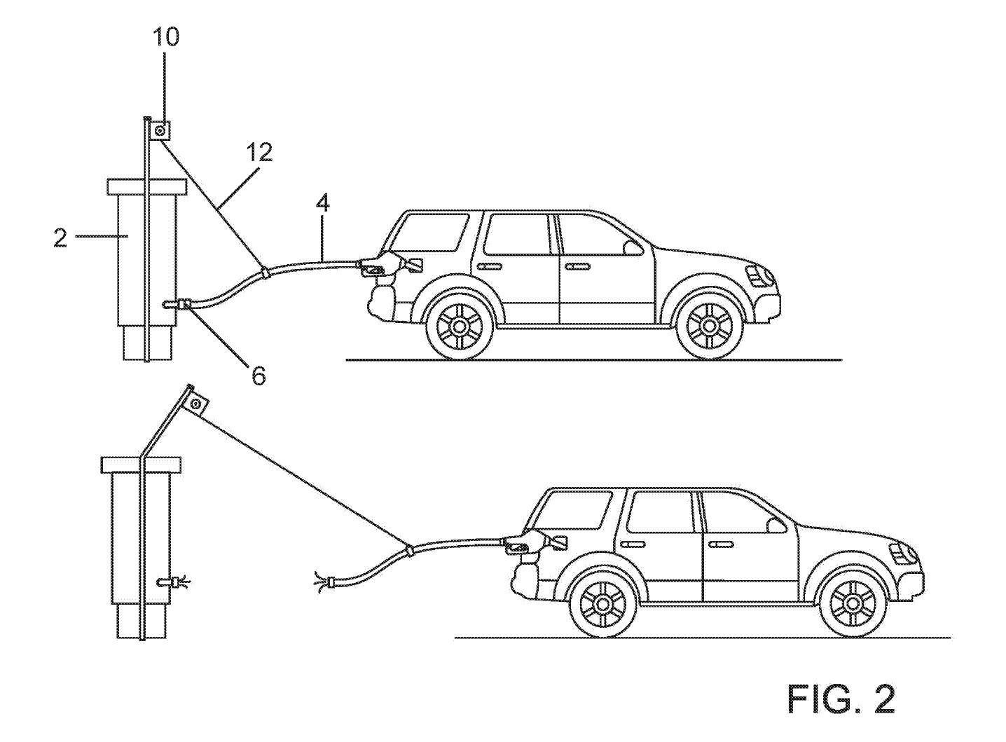

FIG. 3 is a schematic diagram according to an exemplary embodiment of the present invention.

FIG. 4 is a schematic diagram according to an exemplary embodiment of the present invention.

FIG. 5 is a schematic diagram according to an exemplary embodiment of the present invention.

FIG. 6 is a schematic diagram according to an exemplary embodiment of the present invention.

FIG. 7 is a schematic diagram according to an exemplary embodiment of the present invention.

### DETAILED DESCRIPTION OF THE PREFERRED EMBODIMENT(S) AND INVENTION

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

While the illustrations below mostly use fuel dispenser for purpose of demonstration, it should be noted that the devices disclosed herein can apply to any type of retractor cords and hoses. In addition, for purpose of the present disclosure, the fuel dispenser includes, but are not limited to, dispenser for petroleum fuels, gaseous fuels and/or cryogenic fuels.

Broadly, embodiments of the present disclosure generally provide device mounted to the delivery hose of a fuel dispenser which allows retractor cord connecting to the delivery hose to break away from the delivery hose when a force exceeding a designated value is applied to the hose or the device. For example, in a typical fueling application, the hose breakaway might be 300 pounds, the retractor cord breakaway set value typically would be 100 pounds. During normal hose manipulation, the force on the hose retractor cord is less than 100 pounds. The invention consists of a device installed at the connection between the retractor cord and the product hose that detaches at the designated force (for example, 100 pounds). After the cord breaks away from the hose, the retractor reel (typically a spring reel mechanism) rapidly recoils back into the cord retractor unit.

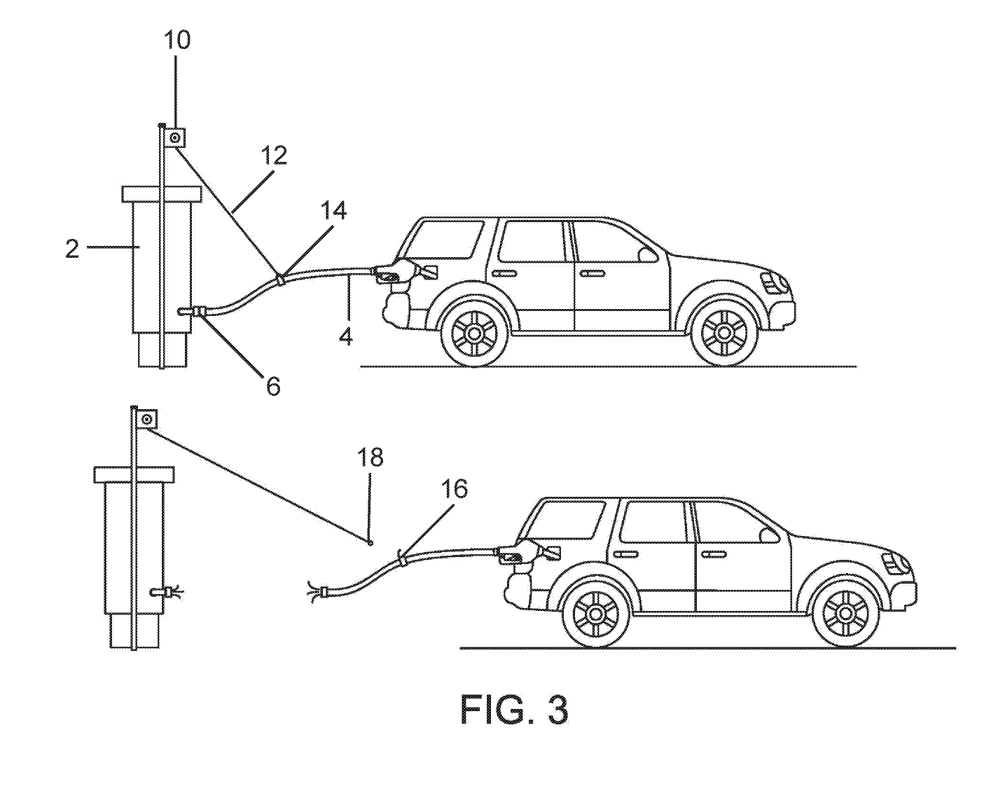

As shown by FIG. 3, in accordance with one embodiment of the present disclosure, the disclosed retractor cord breakaway device 14 comprises a first mating portion 16 that holds a hose 4 and a second mating portion 18 that is secured to one end of the cord 4 of a retractor 10, where the retractor 10 is located on or close to a fuel dispenser 2. The first mating portion 16 is attached to the second mating portion 18 and they are configured in a way that they will break away from each other when a force greater than a designated force is applied to the hose 4. In general, the designated force is an axial force that is greater than the force created during normal manipulation of the hose so that the first mating portion 16 does not break away from the second mating portion 18 or vice versa during normal manipulation of the hose 4 (or the nozzle).

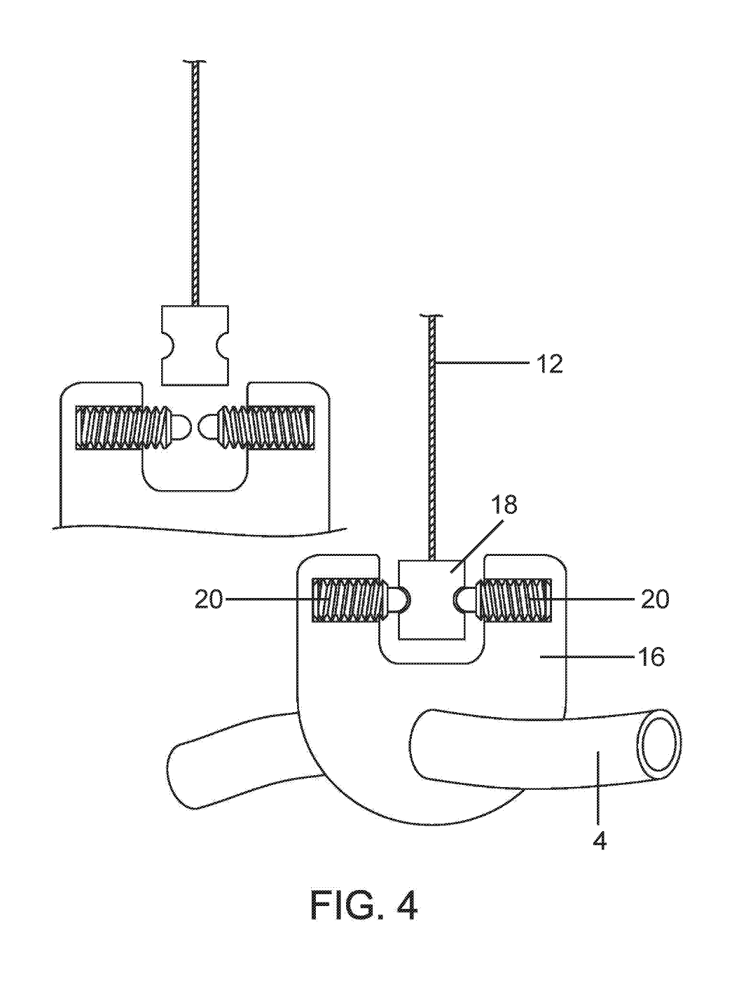

In one embodiment of the present disclosure, as shown by FIG. 4, the first mating portion 16 is designed to have at least two spring plungers 20. The second mating portion 20 is designed to have at least one spherical detent so that the second mating portion 18 is secured to the first mating portion 16 when the at least one spherical detent is inserted between the at least two spring plungers 20. The designated force for the second mating portion 18 to break away from the first mating portion 16 or vice versa can be calculated based on function of angle of incident between mating spherical surfaces.

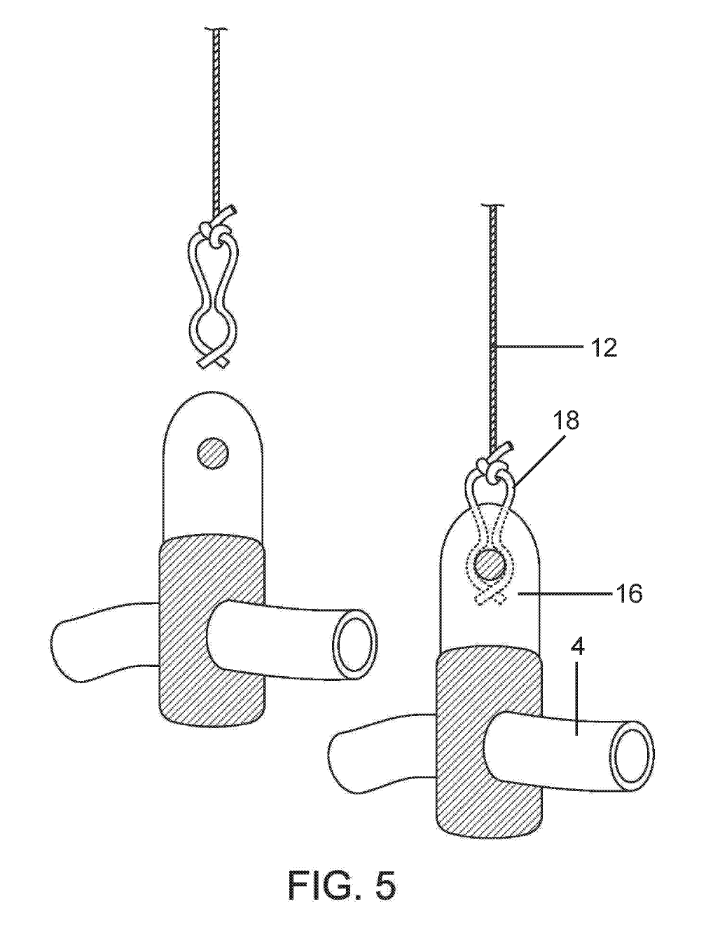

In yet another embodiment of the present disclosure, as shown by FIG. 5, the second mating portion 18 is a spring clip clipping on the first mating portion 16. The clip should be made of flexible and elastic material such as metal. Here, the designated force for the second mating portion 18 (or the clip) to break away from the first mating portion 16 can be calculated based on function of spring k-factor, material modulus of elasticity, spring displacement and geometric interface between the spring clip and the first mating portion. Note there are a lot of different configurations for clipping and FIG. 5 only serves as an illustration. As such, all existing configurations and methods for clipping are also covered by the present disclosure.

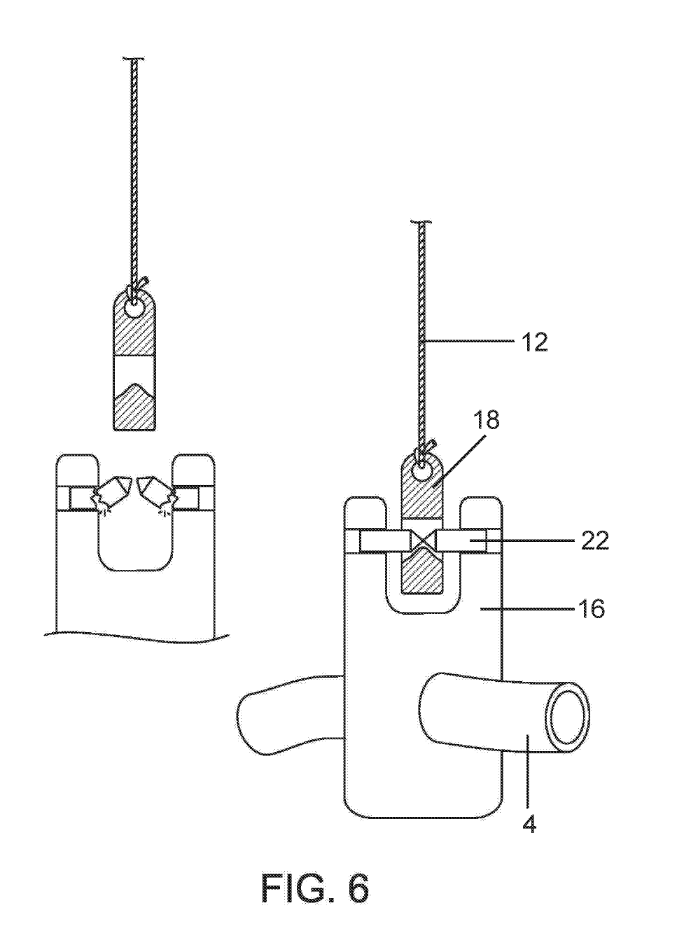

In yet another embodiment of the present disclosure, as shown by FIG. 6, the first mating portion 16 is designed to include at least one single use element 22 that protrude into an opening on the second mating portion 18. When a force greater than the designated force is applied to the hose or between the first mating portion 16 and the second mating portion 18, the at least one single use element 22 will shear, facture or fail, causing the second mating portion 18 to break away from the first mating portion 16 or vice versa. The designated force can be calculated based on the strength of the single use element 22.

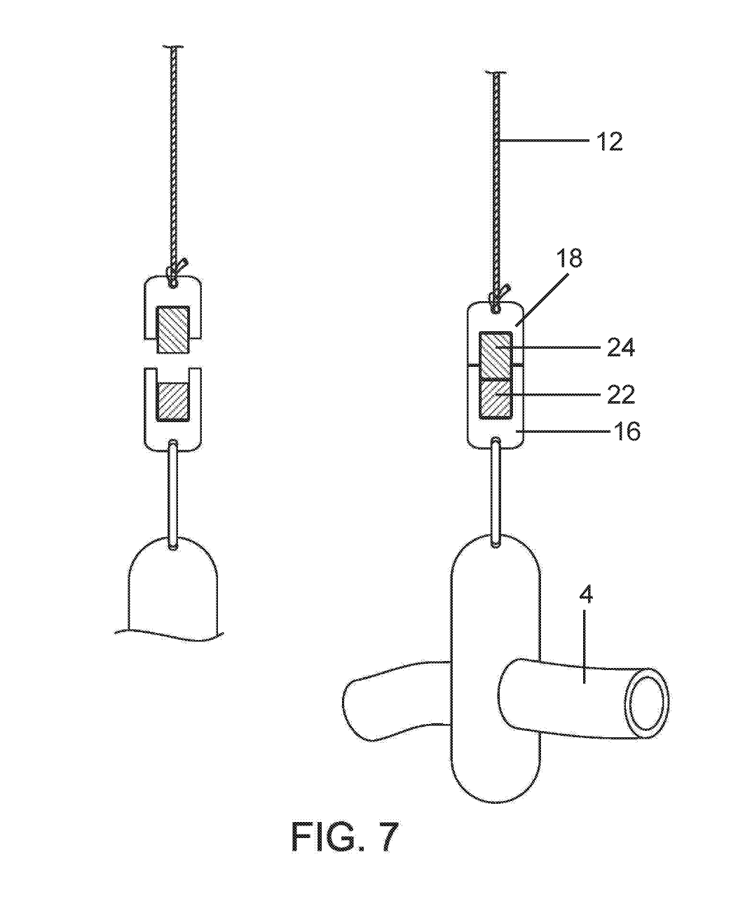

In yet another embodiment of the present disclosure, as shown by FIG. 7, the first mating portion 16 is attached to the second mating portion 18 magnetically and the designated force for the first mating portion 16 and the second mating portion 18 to break away from each other is calculated based on the magnetic attractive force between them. The magnetic connection includes magnet to magnet and magnet to metallic material. For instance, element 24 on the second mating portion 18 can be a magnet while element 22 on the first mating portion 16 is made of a metallic material and vice versa, or element 24 and element 22 can both be magnets.

In yet another embodiment of the present disclosure, the first mating portion 16 and/or the second mating portion 18 is made of a deformable element which yields or bends when a force greater than the designated force is applied to the hose or between the first mating portion 16 and the second mating portion 18.

In yet another embodiment of the present disclosure, the first mating portion 16 and the second mating portion 18 are configured to break away from each other only after the breakaway device for the hose breaks first when a force greater than the force created during normal manipulation of the hose is applied to the hose or between the first mating portion and the second mating portion.

While the present invention discloses several types of configuration for breakaway attachment/detachment mechanisms, it should not be construed that the present disclosures are limited to them. Any type of attachment/detachment mechanisms existed or known to the people skilled in the art shall also be part of the present disclosure.

The key functional element of the disclosed retractor cord breakaway device is to be strong enough to handle normal use where the hose is pulled against the retractor cord for maximum extension and still provide a reliable breakaway limit force point to protect the associated hose and dispenser structures. The invention can be used on any cord retractor application to protect the retractor mechanism for excessive pulling force on the retractor cord in a situation where the hose or other item is pulled away.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A retractor cord breakaway device, the device comprising:
a first mating portion that holds a hose;
a second mating portion that is secured to the end of a retractor cord; and
wherein the first mating portion is attached to the second mating portion and they are configured to break away from each other when a force greater than a designated force is applied to the hose or between the first mating portion and the second mating portion.

2. The device of claim 1, wherein the hose transfers petroleum fuels, gaseous fuels and cryogenic fuels from a fuel dispenser.

3. The device of claim 1, wherein the designated force is greater than the force created during normal manipulation of the hose.

4. The device of claim 2, wherein the retractor cord is connected to a retractor located on or close to the fuel dispenser.

5. The device of claim 1, wherein the first mating portion comprises at least two spring plungers and the second mating portion comprises at least one spherical detent and the first mating portion is attached to the second mating portion when the at least one spherical detent is inserted between the at least two spring plungers.

6. The device of claim 5, wherein the designated force for the second mating portion and the first mating portion to break away from each other is calculated based on function of angle of incident between mating spherical surfaces.

7. The device of claim 1, wherein the second mating portion is a spring clip clipping on the first mating portion.

8. The device of claim 7, wherein the designated force for the second mating portion and the first mating portion to break away from each other is calculated based on function of spring k-factor, material modulus of elasticity, spring displacement and geometric interface between the spring clip and the first mating portion.

9. The device of claim 1, wherein the first mating portion or the second mating portion is made of a deformable element which yields or bends when a force greater than the designated force is applied to the hose or between the first mating portion and the second mating portion, causing the first mating portion and the second mating portion to break away from each other.

10. The device of claim 1, wherein the first mating portion comprises at least one single use element that protrude into an opening on the second mating portion.

11. The device of claim 10, wherein the at least one single use element shears, factures or fails when a force greater than the designated force is applied to the hose or between the first mating portion and the second mating portion, causing the first mating portion and the second mating portion to break away from each other.

12. The device of claim 1, wherein the first mating portion is attached to the second mating portion magnetically and the designated force for the first mating portion and the second mating portion to break away from each other is calculated based on magnetic attractive force.

13. A retractor cord breakaway device, the device comprising:
a first mating portion that holds a hose from a fuel dispenser;
a second mating portion that is secured to one end of a cord from a retractor on or close to the fuel dispenser; and
wherein the first mating portion is attached to the second mating portion and they are configured to break away from each other when a force greater than the force created during normal manipulation of the hose is applied to the hose or between the first mating portion and the second mating portion.

14. The device of claim 13, wherein the first mating portion comprises at least two spring plungers and the second mating portion comprises at least one spherical detent and the first mating portion is attached to the second mating portion when the at least one spherical detent is inserted between the at least two spring plungers.

15. The device of claim 13, wherein the second mating portion is a spring clip clipping on the first mating portion.

16. The device of claim 13, wherein the first mating portion or the second mating portion is made of a deformable element which yields or bends when a force greater than the designated force is applied to the hose or between the first mating portion and the second mating portion, causing the first mating portion and the second mating portion to break away from each other.

17. The device of claim 13, wherein the first mating portion comprises at least one single use element that protrude into an opening on the second mating portion, and the at least one single use element shears, factures or fails when a force greater than the designated force is applied to the hose or between the first mating portion and the second mating portion, causing the first mating portion and the second mating portion to break away from each other.

18. The device of claim 13, wherein the first mating portion is attached to the second mating portion magnetically and the designated force for the first mating portion and the second mating portion to break away from each other is calculated based on magnetic attractive force.

19. A retractor cord breakaway device, the device comprising:
a first mating portion that is secured to a hose connecting a fuel dispenser and a nozzle, wherein the hose has a breakaway device located between the fuel dispenser and the first mating portion;
a second mating portion that is secured to one end of a cord from a retractor on the fuel dispenser; and
wherein the first mating portion is attached to the second mating portion and they are configured to break away from each other when a force greater than the force created during normal manipulation of the hose is applied to the hose or between the first mating portion and the second mating portion.

20. The device of claim 19, wherein the first mating portion and the second mating portion are configured to break away from each other only after the breakaway device for the hose breaks first when a force greater than the force created during normal manipulation of the hose is applied to the hose or between the first mating portion and the second mating portion.
